(19) United States
(12) Patent Application Publication
(10) Pub. No.: US 2025/0273084 A1
(43) Pub. Date: Aug. 28, 2025

(54) CONTROLLED INFORMATION FLOW FROM TEACHER MODEL TO STUDENT MODEL FOR KNOWLEDGE DISTILLATION AND TRANSFER

(71) Applicant: SAMSUNG ELECTRONICS CO., LTD., Suwon-si (KR)

(72) Inventors: Yashas Malur SAIDUTTA, Menlo Park, CA (US); Rakshith Sharma SRINIVASA, Mountain View, CA (US); Jaejin CHO, Mountain View, CA (US); Ching Hua LEE, Bethesda, MD (US); Chou Chang YANG, San Jose, CA (US); Yilin SHEN, Mountain View, CA (US); Hongxia JIN, San Jose, CA (US)

(73) Assignee: SAMSUNG ELECTRONICS CO., LTD., Suwon-si (KR)

(21) Appl. No.: 19/056,152

(22) Filed: Feb. 18, 2025

Related U.S. Application Data
(60) Provisional application No. 63/558,424, filed on Feb. 27, 2024.

(51) Int. Cl. G09B 7/00

(52) U.S. Cl. CPC G09B 7/00

(57) ABSTRACT

A computer-implemented method performed by an electronic device configured to distill knowledge from a teacher model and transfer the distilled knowledge to a student model, includes: obtaining training data; obtaining the teacher model; training at least one rate distortion module (RDM) that is not a teacher assistant (TA) model; training the student model using the trained at least one RDM; and transmitting the trained student model to a first electronic device.

### CROSS-REFERENCE TO RELATED APPLICATION

This application is based on and claims priority under 35 U.S.C. § 119 to U.S. Provisional Patent Application No. 63/558,424, filed on Feb. 27, 2024, in the United States Patent and Trademark Office, the disclosure of which is incorporated by reference herein its entirety.

### BACKGROUND

### 1. Field

The disclosure relates to a system and a method for facilitating a transfer of knowledge from a larger model (a teacher model) to a smaller model (a student model), for example, in the fields of machine learning of artificial intelligence.

### 2. Description of Related Art

Deep neural networks are ubiquitous in their usage today. While large models are constantly pushing the limits of what is technically possible, their practical usage is limited. Large models require huge computation resources to train but most importantly even for deployment (i.e., inference). In the deployment phase, the model is not being trained but used as a tool. However, given the ever-increasing size, run-time memory, and computation requirements, most enterprises provide cloud-based solutions to their clients (i.e., users). This allows the clients to use large models without having to worry about the computational burden. However, this opens up to multiple issues such as constant need for an internet connectivity, bandwidth requirements, load managing at a server, and client data privacy issues.

One possible solution is to use a smaller model that fits on resource and computation-constrained devices. Knowledge Distillation (KD) is a method of improving the performance of a “student model” (a smaller model) by using a “teacher model” (a larger model) to teach insights of the teacher model to the student model. The teacher model, on account of larger modeling capacity, is capable of learning complex relationships in the data. Thus, the teacher model is better at performing target tasks than the student model.

KD attempts to help a training of the student model by showing the student model the insights learned by the teacher model by transferring so-called “dark knowledge” in the logits of a teacher classifier to a student classifier. To facilitate a transfer of the dark knowledge, Kullback-Leibler (KL) divergence between a softened version of a predicted probability distribution of the teacher model and the student model is used, in addition to a classical supervised training of the student model. The dark knowledge is one way of quantifying the insights learned by the teacher model. In general, how to quantify the insights from the teacher model and how to transfer the insights to the student model remain open questions.

In the related art, to facilitate a transfer of knowledge from the teacher model to the student model, training an intermediate model, so-called ‘Teacher Assistant’ (TA) model, has been proposed. However, training the intermediate model (the TA model) from scratch has a knowledge transfer problem itself, and thus, is computationally expensive. Further, the intermediate model is larger than the student model, and thus, is more expensive to train. Thus, this is a need for a solution that is less expensive than the training of the intermediate model (the TA model) of the related art.

### SUMMARY

The disclosure is directed to a system and a method for facilitating a transfer of knowledge from a teacher model to a student model, which are less expensive than a system and a method using an intermediate model (a teaching assistant (TA) model) for the transfer of knowledge from the teacher model to the student model.

The disclosure is directed to a system and a method using a rate-distortion module (RDM) trained to mimic teacher assistants used for knowledge distillation (KD) in a field of artificial intelligence (AI).

The disclosure is directed to a system and a method for training the RDM to mimic a plurality of TA models.

The disclosure is directed to a system and a method for using an information bottleneck module (IBM) to regularize a training of the student model during the transfer of knowledge.

According to an aspect of the disclosure, a computer-implemented method performed by an electronic device configured to distill knowledge from a teacher model and transfer the distilled knowledge to a student model, includes: obtaining training data; obtaining the teacher model; training at least one rate distortion module (RDM) that is not a teacher assistant (TA) model; training the student model using the trained at least one RDM; and transmitting the trained student model to a first electronic device.

In an embodiment, the transmitting the trained student model to a first electronic device, includes: receiving, via a user interface of a display in the electronic device, a user's first command to select the trained student model, receiving, via the user interface, the user's second command to transmit the trained student model to the first electronic device, and transmitting, based on the user's second command, the trained student model to a first electronic device.

In an embodiment, the teacher model is a large language model (LLM) and the student model is a small language model (SLM).

In an embodiment, the teacher model is a pretrained model that is pretrained by an external device.

In an embodiment, the teacher model is a large language model trained by the electronic device.

In an embodiment, the first electronic device is a user terminal.

In an embodiment, the training the at least one RDM, includes: calculating a first loss function based on teacher embeddings and RDM embeddings; calculating a second loss function based on an output of an encoder and noise; determining a total loss function by adding at least the first loss function and the second loss function; and training the at least one RDM using the determined total loss function.

In an embodiment, the computer-implemented method further includes calculating other loss functions, wherein the determining the total loss function by adding at least the first loss function and the second loss function comprises determining the total loss function by the first loss function, the second loss function, and the other loss functions.

In an embodiment, the training the student model using the trained at least one RDM, includes: calculating a first loss function based on teacher embeddings and student embeddings; calculating a second loss function based on RDM embeddings and the student embeddings; calculating a third loss function based on an output of an encoder of an information bottleneck module (IBM) and noise; determining a total loss function by adding at least the first loss function, the second loss function, and the third loss function; and training the at least one RDM using the determined total loss function.

In an embodiment, the computer-implemented method further includes calculating other loss functions, wherein the determining the total loss function by adding at least the first loss function, the second loss function, and the third loss function comprises determining the total loss function by the first loss function, the second loss function, the third loss function, and the other loss functions.

According to an aspect of the disclosure, an electronic device configured to distill knowledge from a teacher model and transfer the distilled knowledge to a student model, includes: at least one memory; a display displaying a user interface; and at least one processor operatively connected with the at least one memory and the display; wherein the at least one processor is configured to perform: obtaining training data; obtaining the teacher model; training at least one rate distortion module (RDM) that is not a teacher assistant (TA) model; training the student model using the trained at least one RDM; and transmitting the trained student model to a first electronic device.

In an embodiment, the at least one processor is further configured to perform: receiving, via the user interface, a user's first command to select the trained student model, receiving, via the user interface, the user's second command to transmit the trained student model to the first electronic device, and transmitting, based on the user's second command, the trained student model to a first electronic device.

In an embodiment, the teacher model is a large language model (LLM) and the student model is a small language model (SLM).

In an embodiment, the teacher model is a pretrained model that is pretrained by an external device.

In an embodiment, the teacher model is a large language model trained by the electronic device.

In an embodiment, the first electronic device is a user terminal.

In an embodiment, the at least one processor is further configured to perform: calculating a first loss function based on teacher embeddings and RDM embeddings; calculating a second loss function based on an output of an encoder and noise; determining a total loss function by adding at least the first loss function and the second loss function; and training the at least one RDM using the determined total loss function.

In an embodiment, the at least one processor is further configured to perform: calculating other loss functions, and determining the total loss function by the first loss function, the second loss function, and the other loss functions.

In an embodiment, the at least one processor is further configured to perform: calculating a first loss function based on teacher embeddings and student embeddings; calculating a second loss function based on RDM embeddings and the student embeddings; calculating a third loss function based on an output of an encoder of an information bottleneck module (IBM) and noise; determining a total loss function by adding at least the first loss function, the second loss function, and the third loss function; and training the at least one RDM using the determined total loss function.

In an embodiment, the at least one processor is further configured to perform: calculating other loss functions, and determining the total loss function by the first loss function, the second loss function, the third loss function, and the other loss functions.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates example components of an electronic device in accordance with some embodiments of the disclosure;

FIG. 2 illustrates an example block diagram of a server in accordance with some embodiments of the disclosure;

FIG. 3 illustrates a set of operations of controlled information flow for knowledge distillation (KD) in accordance with some embodiments of the disclosure;

FIG. 4 illustrates a set of operations of controlled information flow for KD in accordance with some embodiments of the disclosure;

FIG. 5 illustrates a set of operations of controlled information flow for KD in accordance with some embodiments of the disclosure;

FIG. 6 illustrates a set of operations of controlled information flow for KD in accordance with some embodiments of the disclosure;

FIG. 7 illustrates a set of operations of controlled information flow for KD in accordance with some embodiments of the disclosure;

FIG. 8 illustrates examples of practical applications of the above operations in accordance with some embodiments of the disclosure;

FIG. 9 illustrates example set of operations in accordance with some embodiments of the disclosure;

FIG. 10 illustrates example set of operations in accordance with some embodiments of the disclosure; and

FIG. 11 illustrates example set of operations in accordance with some embodiments of the disclosure.

### DETAILED DESCRIPTION

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms should not be interpreted as ideally or excessively formal meanings. Even though a term is defined in the disclosure, the term should not be interpreted as excluding embodiments of the disclosure under circumstances.

The blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

Any of the functions or operations described herein may be processed by one processor or a combination of processors. The one processor or the combination of processors is circuitry performing processing and includes circuitry like an application processor (AP), a communication processor (CP), a graphical processing unit (GPU), a neural processing unit (NPU), a microprocessor unit (MPU), a system on chip (SoC), an IC, or the like.

The disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., via a wire), wirelessly, or via a third element.

A “unit” or a “module” used in the disclosure refer to a hardware component such as a processor or a circuit, and/or a software component executed by a hardware component such as a processor. The “unit” or the “module” may be implemented by a program that is stored in a storage medium which may be addressed, and is executed by a processor. For example, a “unit”, “module” may be implemented by components such as software components, object-oriented software components, class components, and task components, processes, functions, attributes, procedures, sub-routines, segments of a program code, drivers, firmware, a micro code, a circuit, data, a database, data structures, tables, arrays and parameters.

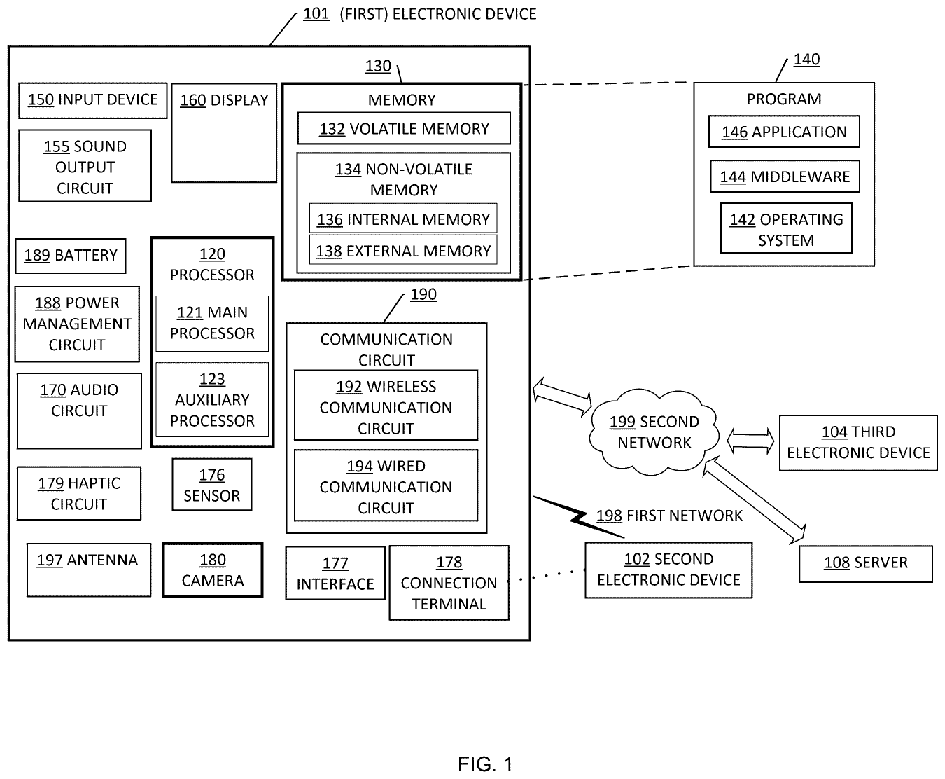

FIG. 1 illustrates example components of the electronic device in accordance with some embodiments of the disclosure.

In FIG. 1, a (first) electronic device 101 may communicate with a second electronic device 102 via a first network 198 (e.g., a short-range wireless communication network), or a third electronic device 104 or a server 108 via a second network 199 (e.g., a long-range wireless communication network). In one embodiment, the (first) electronic device 101 may communicate with the third electronic device 104 via the server 108. Throughout the disclosure, the first electronic device 101 may be referred to as ‘the electronic device 101.’ Hereinafter, components of the electronic device 101 are described. Those components of the electronic device 101 may be also included in the second electronic device 102 or the third electronic device 104. The first electronic device 101, the second electronic device 102, or the third electronic device 104 may be configured to perform methods, steps, or operations described in the disclosure.

In an embodiment, the electronic device 101 may include a processor 120, memory 130, an input device 150, a sound output circuit 155, a display 160, an audio circuit 170, a sensor 176, an interface 177, a connection terminal 178, a haptic circuit 179, a camera 180, a power management circuit 188, a battery 189, a communication circuit 190, or an antenna 197.

In an embodiment, at least one (e.g., the display 160, the sensor 176, or the camera 180) of the components may be omitted from the electronic device 101, or one or more other components may be added in the electronic device 101. In an embodiment, some of the components may be implemented as single integrated circuitry. For example, the sensor 176 (e.g., a fingerprint sensor, an iris sensor, or an illuminance sensor) may be implemented as embedded in the display 160 (e.g., a touch screen). In an embodiment, the electronic device 101 may be a user equipment, a user terminal, a smartphone, a tablet personal computer (PC), a laptop, a PC and/or a server.

In an embodiment, the at least one processor 120 (or the main processor 121 or the auxiliary processor 123) may be implemented in hardware, firmware, or a combination of hardware and software. The at least one processor 120 (or the main processor 121 or the auxiliary processor 123) may include one or more of a central processing unit (CPU), a graphics processing unit (GPU), an accelerated processing unit (APU), a many integrated core (MIC), a field-programmable gate array (FPGA), a digital signal processor (DSP), a neural processing unit (NPU), a hardware accelerator, or a machine learning accelerator. The at least one processor 120 (or the main processor 121 or the auxiliary processor 123) are able to perform control of any one or any combination of the other components of the computing device, and/or perform an operation or data processing relating to communication. The at least one processor 120 (or the main processor 121 or the auxiliary processor 123) execute one or more programs stored in a memory.

The at least one processor 120 (or the main processor 121 or the auxiliary processor 123) may be implemented as one or more multi-core processors that include one or more cores (e.g., homogeneous multi-cores or heterogeneous multi-cores). When a plurality of cores are included in the at least one processor 120 (or the main processor 121 or the auxiliary processor 123), each of the cores includes a cache memory, and a common cache shared by the cores may be included in the at least one processor 120 (or the main processor 121 or the auxiliary processor 123). Each of the cores may independently read and execute program instructions or each of the cores may read and execute one or more portions of program instructions.

In an embodiment, the at least one processor 120 (or the main processor 121 or the auxiliary processor 123) may refer to a system-on-a-chip (SoC) in which one or more cores and other electronic components are integrated, a single core processor, a multicore processor, or a core included in the single core processor or the multicore processor, wherein the core may be implemented as a CPU, a GPU, an APU, an MIC, a FPGA, a DSP, an NPU, a hardware accelerator, or a machine learning accelerator, but the embodiments of the disclosure are not limited thereto.

The processor 120 may execute, for example, software (e.g., a program 140) to control at least one other component (e.g., a hardware or software component) of the electronic device 101 coupled with the processor 120, and may perform various data processing or computation. In one embodiment, as at least part of the data processing or computation, the processor 120 may load a command or data received from another component (e.g., the sensor 176 or the communication circuit 190) in volatile memory 132, process the command or the data stored in the volatile memory 132, and store resulting data in non-volatile memory 134.

In one embodiment, the processor 120 may include a main processor 121 (e.g., a CPU or an AP), and an auxiliary processor 123 (e.g., a graphics processing unit (GPU), an image signal processor (ISP), a sensor hub processor, or a CP) that is operable independently from, or in conjunction with, the main processor 121. Additionally, or alternatively, the auxiliary processor 123 may be adapted to consume less power than the main processor 121, or to be specific to a specified function. The processor 120 may refer to or correspond to one or more processors. For example, the electronic device 101 may include two or more processors like the processor 120. In an embodiment, the main processor 121 and the auxiliary processor 123 may comprise processing circuitry.

The auxiliary processor 123 may be implemented as separate from, or as part of the main processor 121. The auxiliary processor 123 may control at least some of functions or states related to at least one component (e.g., the display 160, the sensor 176, or the communication circuit 190) among the components of the electronic device 101, instead of the main processor 121 while the main processor 121 is in an inactive (e.g., sleep) state, or together with the main processor 121 while the main processor 121 is in an active state (e.g., executing an application). In one embodiment, the auxiliary processor 123 (e.g., an ISP or a CP) may be implemented as part of another component (e.g., the camera 180 or the communication circuit 190) functionally related to the auxiliary processor 123.

For example, the processor 120 of the electronic device 101 may invoke at least one of the one or more instructions stored in the memory 130, and execute the at least one of the one or more instructions, with or without using one or more other components under the control of the processor 120. This allows the electronic device 101 to be operated to perform at least one function according to the at least one instruction invoked. The one or more instructions may include a code generated by a compiler or a code executable by an interpreter. The memory 130, which may be a machine-readable storage medium, may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the memory 130 (the storage medium) and where the data is temporarily stored in the memory 130. In an embodiment, the electronic device 101 may comprise one or more processors (e.g., the main processor 121 and the auxiliary processor 123), and the one or more instructions may be executed by the one or more processors individually or collectively, thereby causing the electronic device 101 to perform any combination of one or more operations (or functions, steps) described herein.

In an embodiment, the memory 130 may include a random-access memory (RAM), a read only memory (ROM), and/or another type of dynamic or static storage device (e.g., a flash memory, a magnetic memory, and/or an optical memory) that stores information and/or instructions for use by the processor 120. In an embodiment, the memory 130 may contain information and/or software related to the operation and use of the electronic device 101. For example, the memory 130 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, or another type of non-transitory computer-readable medium, along with a corresponding drive.

The memory 130 may store various data used by at least one component (e.g., the processor 120 or the sensor 176) of the electronic device 101. The various data may include, for example, software (e.g., the program 140) and input data or output data for a command related thereto. The memory 130 may include the volatile memory 132 or the non-volatile memory 134. The non-volatile memory 134 may include the internal memory 136 or external memory 138. The program 140 may be stored in the memory 130 as software, and may include, for example, an operating system (OS) 142, middleware 144, or an application 146.

One or more embodiments of the disclosure may be implemented as software (e.g., the operating system 142, the application 146, the middleware 144) including one or more instructions that are stored in the memory 130 (comprising one or more storage medium) that is readable by the electronic device 101.

In an embodiment, the input device 150 may receive a command or data to be used by another component (e.g., the processor 120) of the electronic device 101, from the outside (e.g., a user, the second electronic device 102, or the third electronic device 104) of the electronic device 101. The input device 150 may include, for example, a microphone, a mouse, a keyboard, a key (e.g., a button), or a digital pen (e.g., a stylus pen).

In an embodiment, the sound output circuit 155 may output sound signals to the outside of the electronic device 101. The sound output circuit 155 may include, for example, a speaker or a receiver. The speaker may be used for general purposes, such as playing multimedia or playing recorded data. The receiver may be used for receiving incoming calls. According to some embodiments, the receiver may be implemented as separate from, or as part of the speaker.

In an embodiment, the display 160 may visually provide information to the outside (e.g., a user) of the electronic device 101. The display 160 may include, for example, a display device, a hologram device, or a projector and control circuitry to control a corresponding one of the display device, hologram device, and projector. According to some embodiments, the display 160 may include a touch sensor adapted to detect a touch, or a pressure sensor adapted to measure the intensity of force incurred by the touch.

In an embodiment, the audio circuit 170 may convert a sound into an electrical signal and vice versa. According to an embodiment, the audio circuit 170 may obtain the sound via the input device 150 or output the sound via the sound output circuit 155 or a headphone of an external electronic device (e.g., the second electronic device 102 or the third electronic device 104) directly (e.g., via a wire) or wirelessly coupled with the electronic device 101.

In an embodiment, a sensor 176 may detect an operational state (e.g., power or temperature) of the electronic device 101 or an environmental state (e.g., a state of a user) external to the electronic device 101, and then generate an electrical signal or data value corresponding to the detected state.

In an embodiment, the interface 177 may support one or more specified protocols to be used for the electronic device 101 to be coupled with the external entity (e.g., the second electronic device 102, the third electronic device 104, or the server 108) directly (e.g., via a wire) or wirelessly. According to an embodiment, the interface 177 may include, for example, a high-definition multimedia interface (HDMI), a universal serial bus (USB) interface, a secure digital (SD) card interface, or an audio interface.

In an embodiment, the connection terminal 178 may include a connector via which the electronic device 101 may be physically connected with the external electronic device (e.g., the second electronic device 102, the third electronic device 104, or the server 108). According to some embodiments, the connection terminal 178 may include, for example, an HDMI connector, a USB connector, an SD card connector, or an audio connector (e.g., a headphone connector).

In an embodiment, the haptic circuit 179 may convert an electrical signal into a mechanical stimulus (e.g., a vibration or a movement) or electrical stimulus which may be recognized by a user via his tactile sensation or kinesthetic sensation. According to an embodiment, the haptic circuit 179 may include, for example, a motor, a piezoelectric element, or an electric stimulator.

In an embodiment, the camera 180 may capture a still image or moving images (or a set or one or more still images, or video data). According to some embodiments, the camera 180 may include one or more lenses, image sensors, ISPs, or flashes.

In an embodiment, the power management circuit 188 may manage power supplied to the electronic device 101. According to some embodiments, the power management circuit 188 may be implemented as at least part of, for example, a power management integrated circuit (PMIC).

In an embodiment, the battery 189 may supply power to at least one component of the electronic device 101. According to some embodiments, the battery 189 may include, for example, a primary cell which is not rechargeable, a secondary cell which is rechargeable, or a fuel cell.

In an embodiment, the communication circuit 190 may include a transceiver-like component (e.g., a transceiver and/or a separate receiver and transmitter) that enables the electronic device 101 to communicate with other devices (e.g., the second electronic device 102, the third electronic device 104, or the server 108), such as via a wired connection, a wireless connection, or a combination of wired and wireless connections. The communication circuit 190 may permit the electronic device 101 to receive information from another device and/or provide information to another device. For example, the communication circuit 190 may include an Ethernet interface, an optical interface, a coaxial interface, an infrared interface, a radio frequency (RF) interface, a universal serial bus (USB) interface, a Wi-Fi interface, a cellular network interface, or the like. In an embodiment, the communication circuit 190 may be a communication ‘interface’ used to connect the electronic device 101 with the other devices.

In an embodiment, the communication circuit 190 may include one or more CPs that are operable independently from the processor 120 (e.g., an AP) and supports a direct (e.g., wired) communication or a wireless communication. According to an embodiment, the communication circuit 190 may include a wireless communication circuit 192 (e.g., a cellular communication module, a short-range wireless communication module, or a global navigation satellite system (GNSS) communication module) or a wired communication circuit 194 (e.g., a local area network (LAN) communication module or a power line communication (PLC) module).

A corresponding one of these communication modules may communicate with the external electronic device via the first network 198 (e.g., a short-range communication network, such as Bluetooth™, Wi-Fi direct, or IR data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication circuit 192 may identify and authenticate the electronic device 101 in a communication network, such as the first network 198 or the second network 199, using subscriber information (e.g., international mobile subscriber identity (IMSI)).

The antenna 197 may transmit or receive a signal or power to or from the outside (e.g., an external electronic device) of the electronic device 101. According to an embodiment, the antenna 197 may include an antenna including a radiating element composed of a conductive material or a conductive pattern formed in or on a substrate (e.g., a printed circuit board (PCB)). According to an embodiment, the antenna 197 may include a plurality of antennas (e.g., array antennas).

At least some of the above-described components may be coupled mutually and communicate signals (e.g., commands or data) between or among the components via an inter-peripheral communication scheme (e.g., a bus, general purpose input and output (GPIO), serial peripheral interface (SPI), or mobile industry processor interface (MIPI)).

In an embodiment, a set of components (e.g., one or more components) of the electronic device 101 may perform one or more functions described as being performed by another set of components of the electronic device 101.

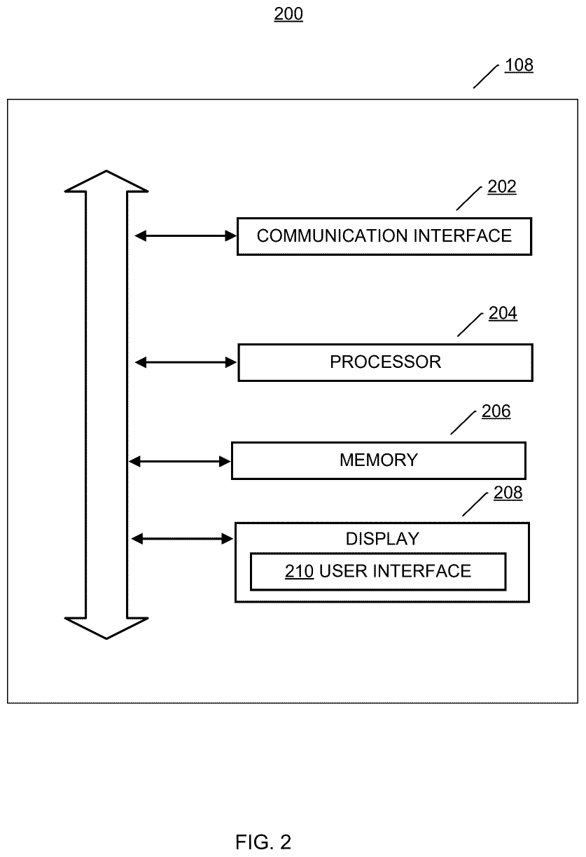

FIG. 2 is an example block diagram of the server 108 in accordance with some embodiments of the disclosure. In FIG. 2, the server 108 may be an electronic device including a communication interface 202, a processor 204, and a memory 206. However, the components of the server 108 are not limited to the above-described examples. The server 108 may include more or fewer components than the aforementioned components. According to an embodiment of the disclosure, some or all of the communication interface 202, the processor 204, and the memory 206 may be implemented as a single chip, and the processor 204 may include one or more processors.

The communication interface 202 is a component for transmitting and receiving signals (e.g., control commands and data) with an external device (e.g., the electronic device 101) by wire or wirelessly, and may be configured to include a communication chipset that supports various communication protocols. The communication interface 202 may receive a signal from an external source and output the signal to the processor 204, or may transmit a signal output by the processor 204 to an external source. According to an embodiment of the disclosure, referring to FIG. 1, the communication interface 11 may perform communication with the electronic device 101 through the second network 199.

In an embodiment, the server 108 may generate a language model and transfer the language model to the electronic device 101 via the communication interface 202.

The processor 204 is configured to control a series of processes so that the server 108 performs any combination of operations in accordance with embodiments described above. The processor 204 may include one or a plurality of processors, each comprising processing circuitry. The one or plurality of processors may be a general-purpose processor such as a CPU, an AP, a DSP; a graphics-only processor such as a GPU or a vision processing unit (VPU); or an Artificial Intelligence (AI)-only processor such as an NPU.

For example, when the one or plurality of processors are AI-only processors, the AI-only processors may be designed in a hardware structure specialized for processing a specific AI model. In an embodiment, the processor 204 may be implemented in a manner similar to that of the processor 120 in FIG. 1.

The processor 204 may write data to the memory 206 or read data stored in the memory 206, and, in particular, may execute one or more programs or one or more instructions stored in the memory 206 to process data according to a predefined operation rule or an AI model. Accordingly, the processor 204 may perform any combination of operations described in the above embodiments. Any combination of operations described as being performed by the server 108 in the above embodiments may be considered as being performed by the processor 204 unless otherwise specified.

According to an embodiment of the disclosure, the memory 206 may store one or more instructions associated with operations of the language model.

In an embodiment, the server 108 may comprises a plurality of processors, and the one or more instructions stored in the memory 206 may be executed by the plurality of processors individually or collectively, causing the server 108 to perform any combination of operations described above.

The memory 206, which is a component for storing various programs or data, may be composed of one or more storage medium, such as ROM, RAM, hard disks, CD-ROM, and DVDs, a floppy disk, a cartridge, a magnetic tape, or another type of non-transitory computer-readable medium, along with a corresponding drive. The memory 206 may not exist separately but may be included in the processor 204. The memory 206 may be implemented as a volatile memory, a non-volatile memory, or a combination of a volatile memory and a non-volatile memory. In an embodiment, the memory 206 may be implemented in a manner similar to that of the memory 130 in FIG. 1.

The memory 206 may store one or more programs, program codes, or instructions for performing any combinations of operations according to embodiments of the disclosure describe above. The memory 206 may provide stored data to the processor 204, in response to a request by the processor 204.

The server 108 may include a display 208 that is configured to show a user interface 210. A user of the server 108 may enter a command, through the user interface 210, to instruct the server 108 to perform functions.

According to an embodiment of the disclosure, the server 108 may perform computer-implemented methods of the disclosure, which are described below.

The system of the disclosure leverages complex data insights learned by the teacher model and transfers the complex data insights to the student model. The teacher model can be obtained as a pretrained model or trained from scratch before the knowledge transfer and is frozen during the entirety of the knowledge transfer. In some embodiments, both of the teacher model and the student model are neural networks.

In some embodiments, the system of the disclosure includes the two phrases: a training phase and an inference phase. In some embodiments, the training phase has two stages: stage 1 and stage 2.

### Stage 1 of the Training Phase

In the stage 1 of the training phase, at least one rate distortion module (RDM) is trained by at least one processor configured to process teacher embeddings (obtained from the teacher model). The at least one RDM is a lightweight model that controls the amount of information passing through it. By controlling the amount of information, different RDMs may mimic different Teacher Assistants (TAs), or different RDMs may be used in lieu of different TAs. This use of the RDM may provide the student model with different granularities of information during the stage 2 of the training phase, which is described below.

In some embodiments, the above training of the at least one RDM may be conducted by the processor of the server 108. In some embodiments, the at least one RDM may be stored or saved in the memory of the server 108.

### Stage 2 of the Training Phase

Once the stage 1 of the training phase is completed, the at least one RDM is frozen (i.e., no longer being trained). During this stage 2, the embedding predictions from the teacher model and the at least one RDM are used to train the student model. In some embodiments, optionally, during this stage 2, an information bottleneck module (IBM), which is described below, may be connected to the student model and be used to regularize embeddings of the student model.

### Inference Phase

After the student model is trained during the stage 2, the trained student model can be used for multiple applications such as image classification, audio classification, zero-shot classification, zero-shot retrievals, provide modality specific encoders for multimodal large language models or distill large language models themselves.

In some embodiments, the student model is trained (through the stage 1 and 2) in a first electronic device (e.g., the server 108X) and the trained student model may be transferred to a second electronic device (e.g., the first electronic device 101 or a mobile device such as a smartphone, a tablet, or a portable laptop). In some embodiments, the second electronic device receives or obtains data (e.g., images) from a data source and use the trained student model to obtain predictions about the data.

Throughout the disclosure, the term ‘module’ (e.g., as in the at least one RDM and the IBM) indicates or correspond to hardware only (e.g., the processor 120), software only (e.g., computer codes or programs stored in the memory 130), or combinations of the hardware and the software. For example, the at least one RDM and the IBM may be implemented by computer codes (e.g., Python or any other programming language).

The at least one RDM (one or more RDMs) and the IBM may be combined differently for different embodiments of the disclosure. Some example combinations of the at least one RDM and the IBM ((Stage 1, Stage 2)) are introduced herein: (one RDM in the stage 1, with the IBM in the stage 2); (one RDM in the stage 1, without the IBM in the stage 2); (multiple RDMs in the stage 1, with the IBM in the stage 2); (multiple RDMs in the stage 1, without the IBM in the stage 2); and (no RDM in the stage 1, the IBM in the stage 2).

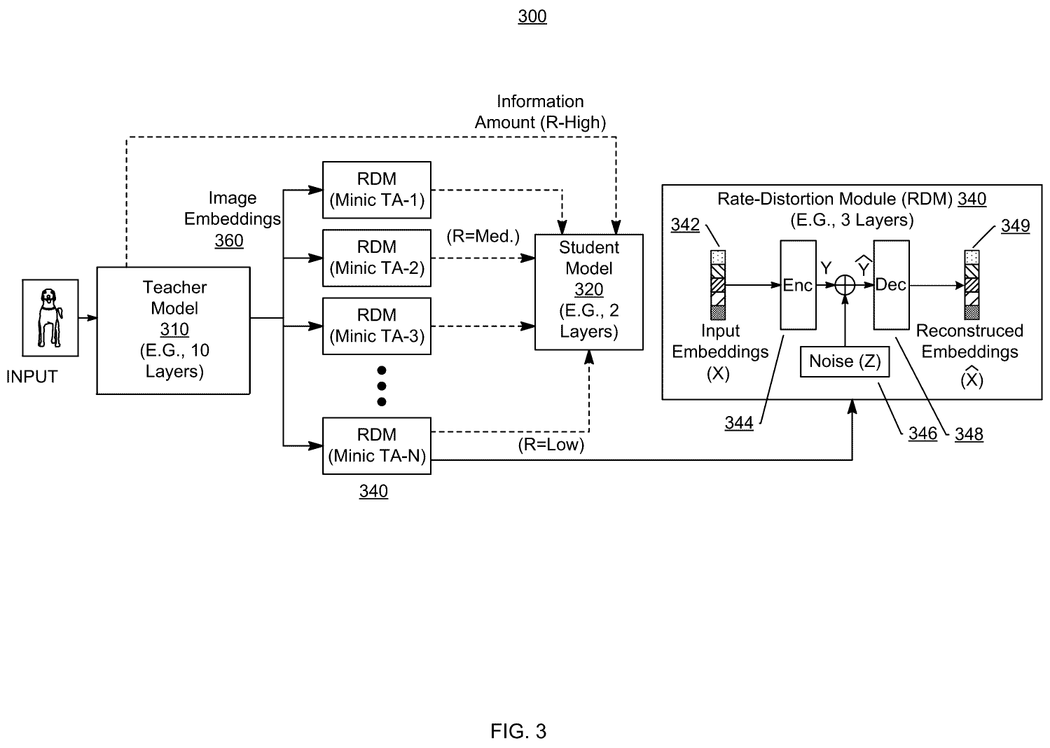

FIG. 3 illustrates operations 300 of controlled information flow for KD in accordance with some embodiments of the disclosure. For example, the operations 300 of controlled information flow for KD may be stored in the memory 130 as computer codes and may be executed by the processor 120. For example, the operations 300 of controlled information flow for KD may be implemented with hardware only (e.g., the processor 120), software only (e.g., computer codes or programs stored in the memory 130), or combinations of the hardware and the software.

As shown in FIG. 3, the operations 300 of controlled information flow for KD includes the teacher model 310, the student model 320, and a plurality of RDMs 340 (or at least one RDM 340). As shown in FIG. 3, the RDM 340 includes an encoder 344 and a decoder 348. The encoder 344 receives input embeddings 342. The decoder 348 receives an input from the encoder 344 and noise 346. The decoder 348 outputs reconstruction embeddings 349. As shown in of FIG. 3, the operations 300 of controlled information flow for KD, the RDMs 340 use the teacher model's embeddings to generate embeddings that mimic Teaching Assistants (TAs). The RDMs 340 process the teacher model's embeddings through a rate constrained communication channel.

The RDM 340 is further described below.

As an example, as illustrated in FIG. 3, the RDM 340 includes only three layers, which are significantly cheaper in computation than the TAs. In other words, the RDM 340 may need about a quarter of computations compared with the TAs, which correspond to lower training cost. Also, a knowledge distillation system having the RDM 340 may have classification accuracy that is similar to the classification accuracy of a knowledge distillation system having the TAs.

Although FIG. 3 illustrates that the RDM 340 has three layers, the disclosure is not limited to the above embodiment. In some embodiments, the RDM 340 may have more than three layers. In some embodiments, the RDM 340 may have less than three layers.

Compared to the TAs, the RDMs 340 are much cheaper to train and use because the RDMs process the teacher model's embeddings and the RDMs 340 do not learn low level feature extractors for an input. By varying the rate constraint, the RDMs 340 may be capable of simulating different TAs.

The operations 300 of controlled information flow for KD distill knowledge (or the insights) from the teacher model 310 to the student model 320, without using intermediate TA models. In operations 300 of controlled information flow for KD, the teacher model's penultimate layer embeddings are processed by the RDMs 340 that imposes a constraint on the amount of information through the RDMs 340.

Using the RDM 340 for the KD has the following advantages. Based on different rate constraints, the RDM 340 may mimic different TAs. In one embodiment, the RDM 340 may include fewer than three (3) hidden layers. Because the RDM 340 operates on the embeddings of the teacher model 310, the RDM 340 may not learn any low-level feature extractors. Accordingly, the RDM 340 may be cheaper to train than the TA, and an inference on the RDM 340 is cheaper than the TA. Thus, the computational burden of the RDM 340 during the training of the student model 320 is reduced.

The operations of the RDM 340 are described below.

The RDM 340 is configured to compress a signal (under rate-distortion theory). Given an input X (e.g., in FIG. 3, the input embeddings 342 or the image embeddings), the RDM 340 is operated to find a mapping from the input X to its compressed version \hat{X} such that \hat{X} has minimal information about X. But, at the same time, the distortion of the input does not exceed D₀. An optimization problem of the RDM 340 is expressed as the following (1) expression:

$${min}_{X \to \hat{X} : D ( X ; \hat{X} ) \leq {D}_{0}} I ( X ; \hat{X} ) \qquad ( 1 )$$

Here, D(·,·) is distortion measure and I(·,·) denotes mutual information between two random variables. The above (1) expression is converted to an unconstrained optimization objective of the form, as shown below:

$$min R \cdot D ( X ; \hat{X} ) + I ( X ; \hat{X} ) \qquad ( 2 )$$

Here, R determines the trade-off between information rate and distortion. A larger R corresponds to more emphasis on minimizing the distortion at the cost of a higher information rate and vice-versa. The above (2) expression may be understood in the context of lossy compression that compresses as much as possible while allowing tolerable distortion.

The RDM 340 is operable under the rate-distortion theory that is applicable to compression and also to problems like joint source-channel coding where the compressed representation is subject to noise. As shown in FIG. 3, the encoded representation of the input X is denoted as Y and its noisy version as Ŷ. The independent noise added to encoded representation is denoted as Z.

The rate-distortion theory indicates what an optimization problem to be solved, but the rate-distortion theory may not provide how to solve the optimization problem. When the encoder 344 and the decoder 348 in FIG. 3 are neural networks, the optimization problem is compounded because the objective may not be computed (I(X;\hat{X}) is intractable).

Thus, the operations 300 of controlled information flow for KD may use variational approximations to compute an upper bound on the objective, which, in turn, will perform gradient descent to learn the encoder 344 and the decoder 348. q(Ŷ) is denoted as an approximation of true but unknown distribution of Ŷ, p(Ŷ). Then, an upper-bound on I(X;\hat{X}) may be computed as shown below:

$$I ( X ; \hat{X} ) \leq I ( Y ; \hat{Y} ) \leq {H}_{q} ( \hat{Y} ) + H ( \hat{Y} \vert Y ) \qquad ( 3 )$$

Here, H(·) denotes the entropy, and H_{q}(Ŷ) denotes the cross entropy computed using the distribution q(Ŷ). The first (left) inequality of the above expression (3) follows from the data processing inequality. The second inequality (right) of the above expression (3) follows because cross-entropy may be greater than entropy. Finally, note that H(Ŷ|Y) is constant because the noise is independent of the encoder parameter and the decoder parameter.

In the above expression (3), the approximating distribution q needs to be chosen. Examples of the approximating distribution q are the Gaussian distribution when the noise is Gaussian (results in an objective similar to the ELBO objective popularized by Variational Autoencoders), learning the distribution, or non-parametric approximations when the noise is uniform. All these methods may yield a mechanism that computes q(Ŷ).

In an embodiment, distortion measure D is the L₂ norm, then the parameters of the encoder (Θₑ) and the decoder (Θ_{d}) may be learned by minimizing the following expression:

$${ℒ}_{R} = {𝔼}_{X , Z} [ R {‖ X - \hat{X} ‖}_{2}^{2} - log ( q ( \hat{Y} ) ) ] \qquad ( 4 )$$

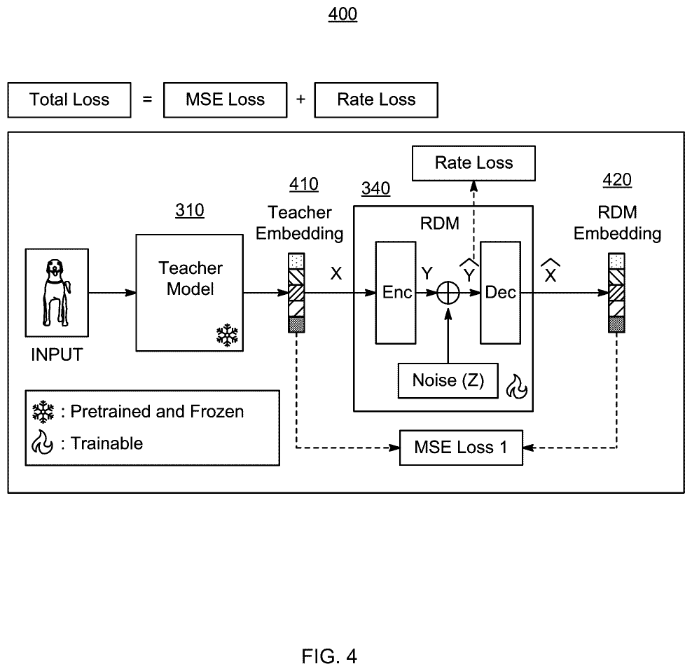

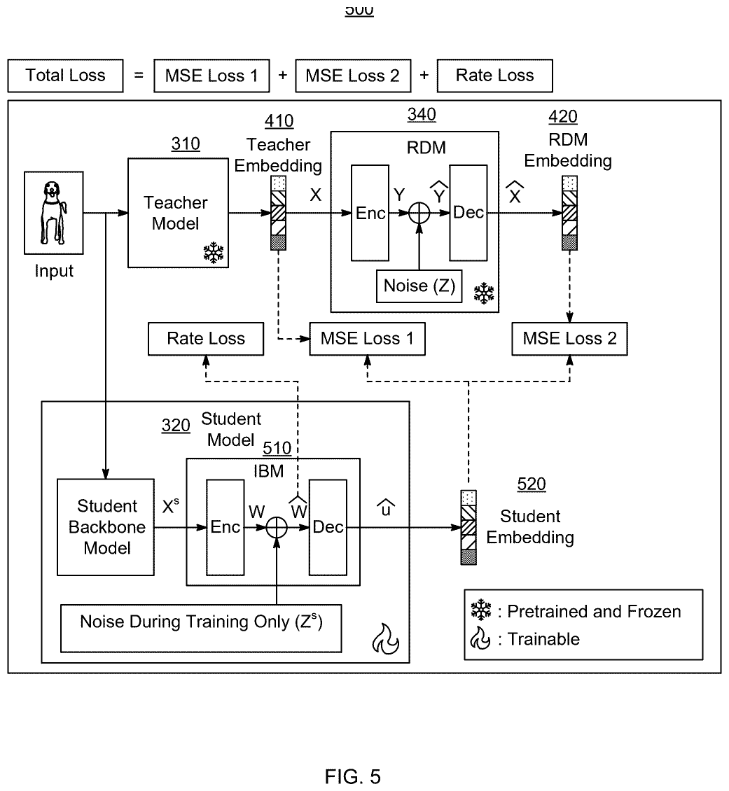

FIG. 4 illustrates another set of operations 400 of controlled information flow for KD, which performs a training of the RDM 340 to mimic a TA. Specifically, FIG. 4 illustrates how the RDM 340 is trained. FIG. 4 illustrates the stage 1 of the training phase. In stage 2 of the training phase (illustrated in FIG. 5), the RDM 340 is frozen and the student model 320 is trained. During this time, the knowledge is transferred from the teacher model 310 via the teacher embedding 410 and from the RDM network 340 via the RDM embedding 420. Throughout the present disclosure, the teacher embedding 410 may correspond to the input embeddings 342 (of FIG. 3 and the RDM embedding 420 may correspond to the reconstructed embeddings 349 (of FIG. 3).

In FIG. 4, because the RDM 340 processes the teacher embeddings 410 (received from the teacher model 310), the RDM 340 does not have to learn low-level feature extractors from the input, thus making the RDM 340 computationally cheaper compared to the TA.

As shown in FIG. 4, the training of the RDM 340 includes calculating a ‘mean squared error’ (MSE) loss function and a rate loss function. A sum of these loss functions correspond to a total loss function. As known in the art, a loss function quantifies an error margin between a model's prediction and the actual target value. The loss function, also referred to as the error function, quantifies a difference between the predicted outputs of a machine learning model and actual target values. The loss function is a mathematical formulation of an objective of machine learning tasks.

The RDM embedding 420 may be used to train the student model 320. In FIG. 5, the student embeddings 520 are trained to mimic both the teacher embeddings 410 and the RDM embeddings 420 using the MSE loss function (i.e., “MSE Loss 1” and “MSE Loss 2” in FIG. 5). In some embodiments, the MSE loss function may be replaced with other types of loss functions such as mean-absolute-error (MAE) loss function or smooth MAE loss function. FIG. 3 is a high-level representation of the system proposed in the disclosure, while FIG. 5 illustrates details as to how the proposed system is trained.

FIG. 5 illustrates another set of operations 500 of controlled information flow for KD, which performs a training of the student model 320 using the trained RDMs 340 and the teacher model 310.

How the RDMs 340 mimic the TAs is described herein.

The TAs may limit the amount of information extracted from the input by using limited model capacity. The lesser the model capacity, the poorer the TA performance on a downstream task. On the other hand, the operations 500 of controlled information flow for KD may limit the amount of information (extracted from the teacher model's embedding) by passing the information through a rate constrained communication channel. If a higher constraint on the information is placed through the communication channel, reconstructed embeddings may have more distortion compared to the teacher model's and may perform poorly on the downstream task, just like the embeddings from a TA with a small model capacity. Thus, by choosing different Rs in the above expression (4), different TAs may be mimicked.

In a case where a classification model is distilled, an additional linear layer may be used to convert the reconstructed embeddings to logits. Let V represent the true classification label, \hat{V}_{T} represent the teacher's output predictive distribution on the class labels, \hat{V}_{RDM} be the same but as predicted by the RDM output. Then, the loss function used to train the RDM for classification is [symbol] ′RC:

$${𝔼}_{X , Z} [ {ℒ}_{CE} ( V , \hat{V} ) + {λ}_{KL} KL ( {\hat{V}}_{T} ‖ {\hat{V}}_{RDM} ) ] + {ℒ}_{R} \qquad ( 5 )$$

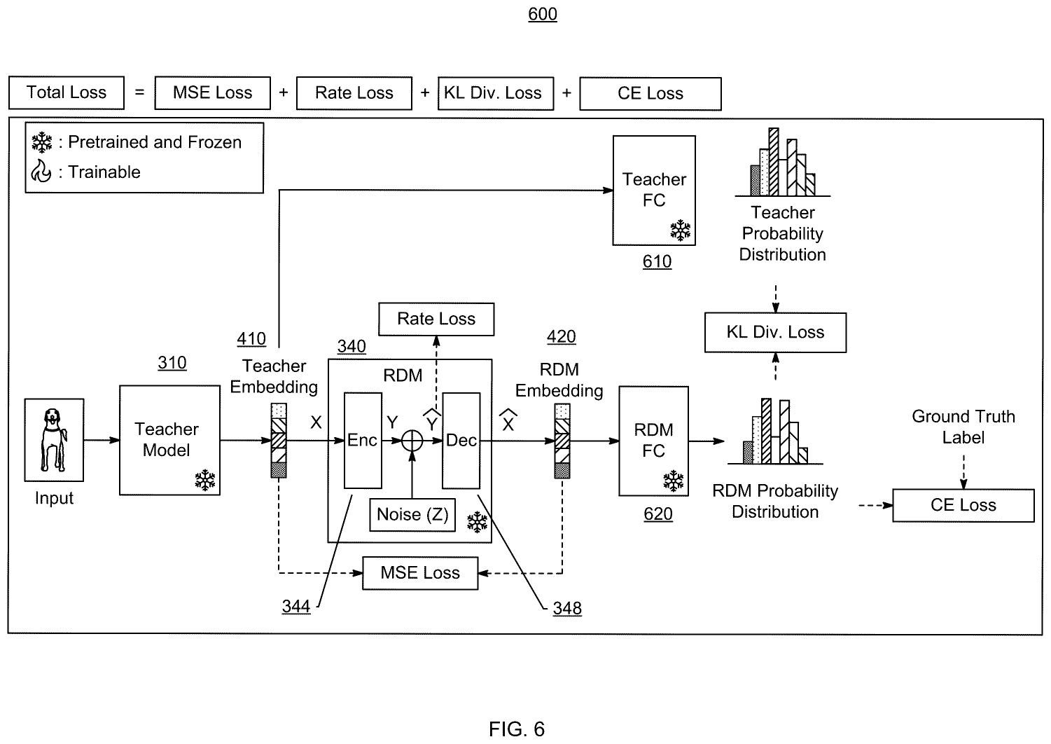

Here, [symbol] _{CE} is the cross-entropy loss, KL( ) is the Kullback-Leibler divergence, and λ_{KL} is weighting factor for KL( ) loss. FIG. 5 illustrates an example of the IBM 510. FIG. 6 illustrates how the RDM 340 is trained for classification.

The IBM 510 is described below.

FIG. 5 illustrates an example of the IBM 510. As a number of the RDMs 340 increases, the student model 320 may face a tendency to ‘overfit’ to stronger teacher models and stronger TAs. Thus, it may be important to constrain information from the student model 320 that is exposed to feedback from the teacher model 310 and the RDMs 340. The IBM 510, which is a module (or computer codes) about ‘information bottleneck’ in the student model 320, may regularize the training. In an embodiment, the IBM 510 and the operations 300 of controlled information flow for KD may be performed together when the information is constrained both on the teacher model 310 and the student model 320.

As described above, the RDMs 340 may be configured to control the flow of information from the teacher model 310 and mimic the TAs. The teacher model 310 and multiple RDMs 340 may provide feedback that may cause the student model to overfit and lead to poor performance. The overfit problem may be overcome by constraining the information from the student model 320 to be exposed to the feedback (i.e., partial feedback). In the operations 500 of controlled information flow for KD, similar to the teacher model 310, the student model 320 may use another rate-constrained channel to constraint the information.

Further, this rate-constrained model (i.e., the student model 320 using another rate-constrained channel) may be present only when there is feedback to the student model 320, i.e., only during a training of the student model 320. However, unlike the case of the RDMs 340, the rate-constrained model may not reconstruct the input to the rate constrained channel. Instead, the rate-constrained model may reconstruct the teacher model 310 or RDM embeddings. In information theory, the rate-distortion problem (where information about another random variable is retained in the compressed representation) is similar to an information bottleneck problem. Thus, the above rate-constrained model may be called as the IBM 510.

Information bottleneck principle is a generalization to the rate-distortion problem. Given an input X_{S} (shown in FIG. 5) and some random variable of interest U, the goal in the information bottleneck is to find a representation Û (shown in FIG. 5) that removes as much information about input X_{S} while retaining as much information about U. This is formulated as:

$$min - I ( U ; \hat{U} ) + {λ}_{I} I ( {X}_{S} ; \hat{U} ) \qquad ( 6 )$$

Here, λ₁, is the Lagrange multiplier.

FIG. 5 shows the IBM in the student model. X_{S} represents the input, W represents the encoded representation, Ŵ is the noisy encoded representation, Z_{S} is the noise added during training only, and Û represents the output of the IBM decoder.

When working with neural network-based encoders and decoders, both the mutual information terms in the above expression (6) may be intractable (not easily controlled or directed). The operations 500 of controlled information flow for KD may include variational approximations, resulting in an upper bound on the information bottleneck objective (6), which is represented as below:

$${ℒ}_{1} = {𝔼}_{X , Z} [ D ( U , \hat{U} ) - {λ}_{I} log ( r ( \hat{W} ) ) ] \qquad ( 7 )$$

where D represents a suitable distortion metric, r(Ŵ) is the approximation of the true distribution p(Ŵ).

In the IBM 510, U is set to be the teacher model's (or RDM's) embedding. So, at the output, the IBM 510 attempts to reconstruct the teacher model's (or RDM's) embedding. In a case of a dimensionality mismatch, a projection layer is used. In an embodiment, a dedicated encoder for the IBM 510 may not be used and the student backbone model itself may become the encoder, i.e., W=X_{S}. In an embodiment, the decoder of the IBM 510 is a simple network of at most one or two linear layers. In an embodiment, the IBM may not be trained separately, instead the IBM may be trained along with the student model.

The IBM 510 may be used for a masked image modeling (MIM) as described below.

As known in the art, the MIM is a computer vision technique that involves predicting missing pixels in an image by using surrounding pixels as context. The MIM is often used in image inpainting, where missing or damaged parts of an image are filled in using information from the surrounding areas.

The MIM has been successful in pretraining large image models. In the MIM, an image is first converted into tokens using a pretrained tokenizer. Next, a masked version of the image is fed into the MIM encoder that attempts to predict the tokens of the masked parts. Masked tokens may be a random variable of interest for the IBM (U). The predicted tokens from the large image model encoder may be Û.

An upper-bound on the above expression (6) may be obtained by using the data processing inequality I(X;Û)≤I(X;X_{M}), wherein Û is a function of X_{M} (say f):

$$min - {𝔼}_{{X}_{M}} [ log p ( U \vert f ( {X}_{M} ) ) ] + {λ}_{MIM} I ( X ; {X}_{M} ) - H ( U ) \qquad ( 8 )$$

Here, the second term I(X;X_{M}) and the third term H(U) are constants regarding the parameters of the large image model encoder. The first term of the above expression (8) is the same as the training objective of the large image model. This shows that the training objective is an application of the information bottleneck principle for pretraining a large image model, except that unlike usual information bottleneck, the bottleneck is applied at the input, i.e., the masking. The amount of masking implicitly determines the information rate-constraint.

Unlike the MIM where the target U comes from the tokenizer, in the operations of controlled information flow for KD, the target U comes from the teacher model in the form of the embeddings of the teacher model. Further, while the masking applies an implicit rate-constraint, in the operations of controlled information flow for KD, an explicit rate-constraint is applied by minimizing an upper bound on the mutual information during the training.

A final loss function of the operations of controlled information flow for KD is described below.

In an embodiment, using the operations described above, a plurality of the RDMs 340 (N RDMs), which respectively correspond to different rate-constraints, may be trained. X is the input datapoint. The teacher model's embedding of X is U_{T}; Uₙ, Zₙ (the embedding and noise in the nth RDM respectively). U_{S} corresponds to the student model's embedding. In an embodiment, the loss to match embeddings is the L₂ loss. Then, the loss function for training the student model 320 may be described as [symbol] _{CIFD}:

$${𝔼}_{X , {Z}_{1}^{N} , {Z}_{S}} [ {‖ {U}_{S} - {U}_{T} ‖}_{2}^{2} + {\sum }_{n = 1}^{n = N} {λ}_{n} {‖ {U}_{S} - {U}_{n} ‖}_{2}^{2} - {λ}_{I} log r ( \hat{W} ) ] \qquad ( 9 )$$

Here, λₙ are weighting coefficients.

In a case of classification, the output predictive distribution of the teacher model 310 may be denoted as \hat{V}_{T}, \hat{V}_{S} for the student model, \hat{V}_{Tn} for the nth RDM, and the true label as V. The loss function for training the student model 320 may be described as:

$${ℒ}_{CIFD}^{′} = {𝔼}_{X , {Z}_{1}^{N} , {Z}_{S}} [ {λ}_{CE} {ℒ}_{CE} ( V , {\hat{V}}_{S} ) + {λ}_{KL} KL ( {\hat{V}}_{T} ‖ {\hat{V}}_{S} ) + {λ}_{KL} {\sum }_{n = 1}^{n = N} {λ}_{n} KL ( {\hat{V}}_{n} ‖ {\hat{V}}_{S} ) ] + {ℒ}_{CIFD} \qquad ( 10 )$$

The operations of controlled information flow for KD of the present disclosure may be used for contrastive language-image pretraining (CLIP) as described below.

CLIP is a technique for training a pair of neural network models, one for image understanding and the other for text understanding, using a contrastive objective. CLIP has enabled multiple applications across multiple domains such as text-to-image generation and image capturing.

CLIP is a class of foundational models that are capable of embedding inputs from distinct modalities into a shared embedding space. In CLIP, a modality specific encoder processes the input from a specific modality and embeds the processed input into a shared embedding space. CLIP-like models have shown tremendous performance in zero-shot classification, object-detection, and retrieval. Further, the trained encoders have also proved instrumental in powering large multimodal models (LMMs) and generative models. Thus, distillation of these CLIP-like models has far-reaching applications especially in on-device generative artificial intelligence (AI).

In one embodiment, two modalities, Image ( [symbol] ) and Language ( [symbol] ), and a batch of B image-text pairs {(I⁽¹⁾,L⁽¹⁾), . . . , (I^{(B)},L^{(B)})} are considered. [symbol] denotes the L₂-normalized embedding of the v-th image obtained from the image encoder. [symbol] denotes the same for the b-th text obtained from the language encoder. Then, the contrastive loss from an image to language embeddings is expressed as:

$${ℒ}_{CL , 𝕀 \to 𝕃} = \frac{- 1}{B} {\sum }_{b = 1}^{B} log \frac{exp ( 〈 {U}_{𝕀}^{( b )} , {U}_{𝕃}^{( b )} 〉 / τ )}{{\sum }_{k ∈ [ B ]} exp ( 〈 {U}_{𝕀}^{( b )} , {U}_{𝕃}^{( k )} 〉 / τ )} \qquad ( 11 )$$

where [symbol] ·,· [symbol] represents the inner-product between the two vectors. The loss to train CLIP-like models is represented as:

$${ℒ}_{CL} = {ℒ}_{CL , 𝕀 \to 𝕃} + {ℒ}_{CL , 𝕃 \to 𝕀} \qquad ( 12 )$$

In contrastive loss, embeddings of a paired set of an image and a text are close to each other (e.g., high inner-product) compared to embeddings of a non-paired set of an image and a text.

Because the CLIP teacher model has modality-specific encoders, each encoder may have its own set of RDMs. Each of the set of RDMs 340 may be trained using the above expression (4). The embeddings for b-th image and text from the teacher are denoted as [symbol] and [symbol] , respectively. The n-th RDM embeddings are defined as [symbol] and [symbol] .

Similarly, because the student model 320 has modality-specific encoders, the student model 320 has modality-specific IBMs. [symbol] , [symbol] (similar to Ŵ in FIG. 5) for the image encoder IBM and the language encoder IBM, respectively. The output of the IBM decoder for the b-th image and text is denoted as [symbol] and [symbol] , respectively. Then, the modality-specific CIFD loss for CLIP distillation is described as:

$${ℒ}_{CIFD , 𝕀} = \frac{1}{B} {\sum }_{b = 1}^{B} [ {‖ {U}_{S , 𝕀}^{( b )} - {U}_{T , 𝕀}^{( b )} ‖}_{2}^{2} + {\sum }_{n = 1}^{n = N} {λ}_{n} {‖ {U}_{S , 𝕀}^{( b )} - {U}_{n , 𝕃}^{( b )} ‖}_{2}^{2} - {λ}_{I , 𝕀} log {r}_{𝕀} ( {\hat{W}}_{𝕀} ) ]$$

(13)

With all components in place, the final loss (to perform distillation of CLIP using the operations of controlled information flow for KD) is described as:

$${{ℒ}^{″}}_{CIFD} = {λ}_{CL} {ℒ}_{CL} + {ℒ}_{CIFD , 𝕀} + {ℒ}_{CIFD , 𝕃} \qquad ( 14 )$$

Here, λ_{CL} is weighting factor.

Operations for training the RDM 340 for classification tasks are described below in view of the example embodiment shown in FIG. 6.

FIG. 6 illustrates another set of operations 600, which includes training the RDMS 340 and the student model 320 for classification tasks.

In FIG. 6, the input (e.g., an image) is passed through the teacher (backbone) model 310. The teacher embedding 410 is passed through the encoder 344 of the RDM 340, subject to noise (Z) and is reconstructed by the decoder 348 of the RDM 340. In the case of classification, the RDM 340 is trained like a multi-task learning module. That is, the RDM 340 is tasked with reconstructing both the input embedding and projecting the reconstructed embedding to perform classification. The RDM 340 is trained in a similar fashion to the student model 320 during KD, i.e., there is feature distillation (reconstructing the teacher embedding), logit distillation to preserve the dark knowledge, and a supervised cross entropy loss component. The resulting loss function used to train the RDM is described as shown below:

$${{ℒ}^{′}}_{R} = {𝔼}_{X , Z} [ {λ}_{CE} {ℒ}_{CE} ( V , \hat{V} ) + {λ}_{KL} KL ( {\hat{V}}_{T} ‖ {\hat{V}}_{RDM} ) + R {‖ X - \hat{X} ‖}_{2}^{2} - log ( q ( \hat{Y} ) ) ] \qquad ( 15 )$$

That is, as shown in FIG. 6, the total loss is equal to a sum of the MSE loss, the rate loss, KL Div. loss (that is, Kullback-Leibler divergence loss), and the CE loss (that is, cross entropy loss).

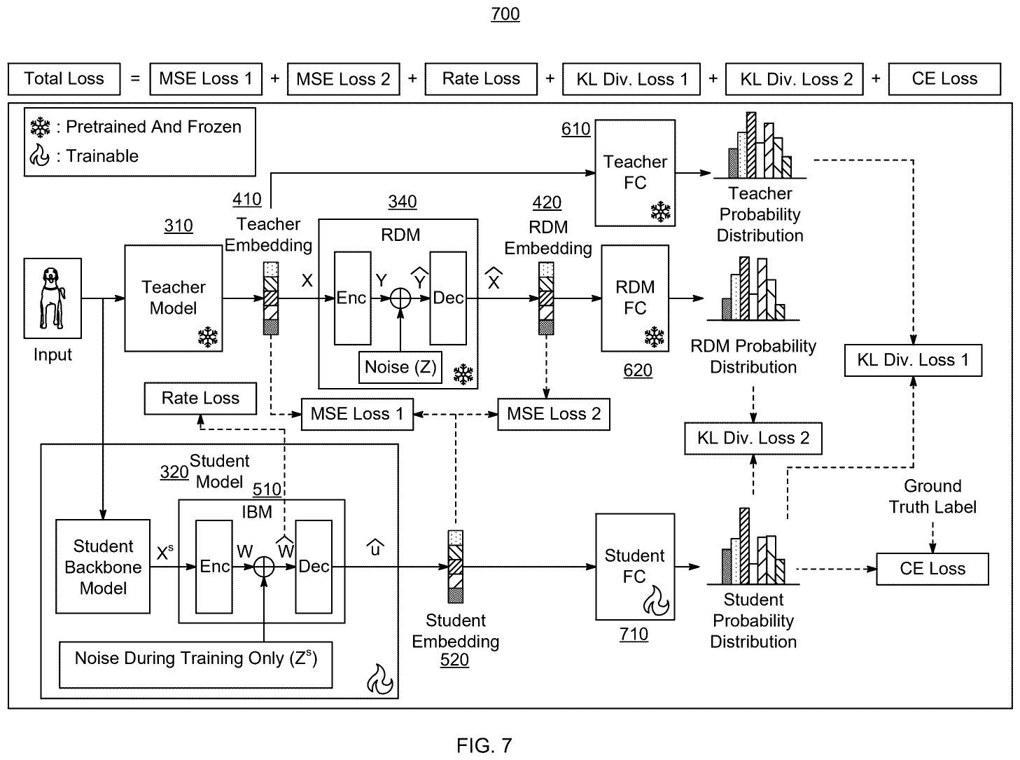

FIG. 7 illustrates another set of operations 700, which include training the student model 320 for classification. FIG. 7 illustrates how the student models 320 are trained for classification in the presence of the RDM 340 and the IBM 510. FIG. 7 also illustrates the teacher FC 610, the RDM FC 620, and a student FC 710.

In an embodiment, there is one RDM 340. As illustrated in FIG. 7, the input image is passed through the teacher (backbone) model 310 and the obtained embedding is passed through the RDM 340 to get the reconstructed embedding from the RDM 340. Then, the RDM 340 provides a predictive distribution (like a TA) and the teacher model's predictive distribution is obtained.

The input image is also passed through the student model 320 and the IBM 510 to obtain the student embedding 520 that is then subject to feature distillation, i.e., the loss between the student embedding 520 and the teacher embedding 410 and the loss between the student embedding 520 and the RDM embedding 420 are computed. In a case where a dimension of the student model's embedding does not match with a dimension of the teacher model's embedding or the RDM's embedding, a small trainable projector network is used. Finally, the output predictive distribution of the student model 320 is subject to both the classification loss and the KL divergence losses with respect to the teacher model's distribution and the RDM's distribution.

So, the set of operations 700 combines feature distillation and the output logit distillation along with the RDM 340. FIG. 7 shows one RDM as an example. However, the disclosure is not limited to one RDM 340. Embodiments of the disclosure may include multiple RDMs 340 (for example, as illustrated in FIG. 4).

The loss function used in the set of operations 700 is:

$${{ℒ}^{′}}_{CIFD} = {𝔼}_{X , {Z}_{1}^{N} , {Z}_{S}} [ {λ}_{CE} {ℒ}_{CE} ( V , {\hat{V}}_{S} ) + {λ}_{KL} KL ( {\hat{V}}_{T} ‖ {\hat{V}}_{S} ) + {λ}_{KL} {\sum }_{n = 1}^{n = N} {λ}_{n} KL ( {\hat{V}}_{n} ‖ {\hat{V}}_{S} ) + {‖ {U}_{S} - {U}_{T} ‖}_{2}^{2} + {\sum }_{n = 1}^{n = N} {λ}_{n} {‖ {U}_{S} - {U}_{n} ‖}_{2}^{2} - {λ}_{I} log r ( \hat{W} ) ] \qquad ( 16 )$$

That is, as illustrated in FIG. 7, the total loss is equal to a sum of the MSE loss 1, the MSE loss 2, the rate loss, the KL div. loss 1, the KL div. loss 2, and the CE loss.

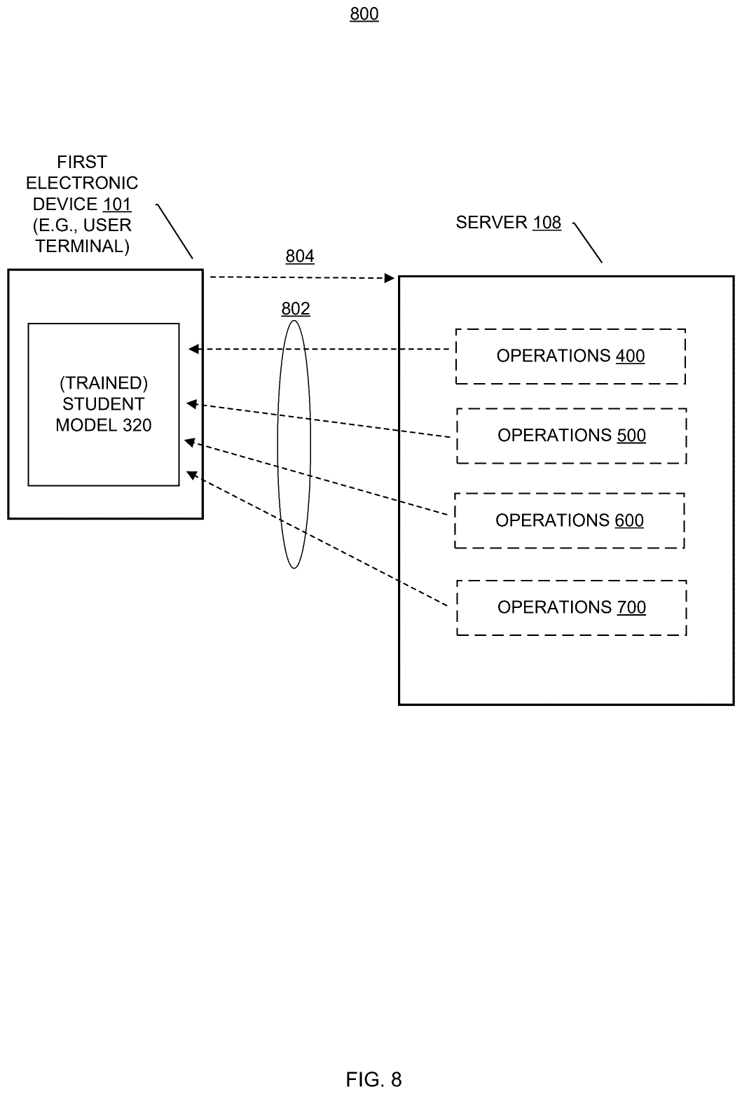

FIG. 8 illustrates examples of practical applications of the operations described above. As illustrated in FIG. 8, a system 800 (e.g., a cloud system, a computer system) includes the first electronic device 101 (e.g., a user terminal) and the server 108. FIG. 1 illustrates example components of the first electronic device 101. FIG. 2 illustrates example components of the server 108.

As illustrated in FIG. 8, the server 108 may perform at least one of the operations 300, 400, 500, 600, and 700 that are described above. After the server 108 preforms the at least one of these operations, the output of the operations, which is a trained student model 320 (i.e., a student model 320 trained with the teacher model 310 and the RDM 340 at the server 108), is transferred to the first electronic device 101 (operation 802). In one embodiment, the first electronic device 101 transmits a request (operation 804) for the trained student model 320 to the server 108. Based on the request from the first electronic device 101, the server 108 may forward the trained student model 320 to the first electronic device 101. In one embodiment, the server 108 may forward the trained student model 320 to the first electronic device 101, although there is no prior request from the first electronic device 101.

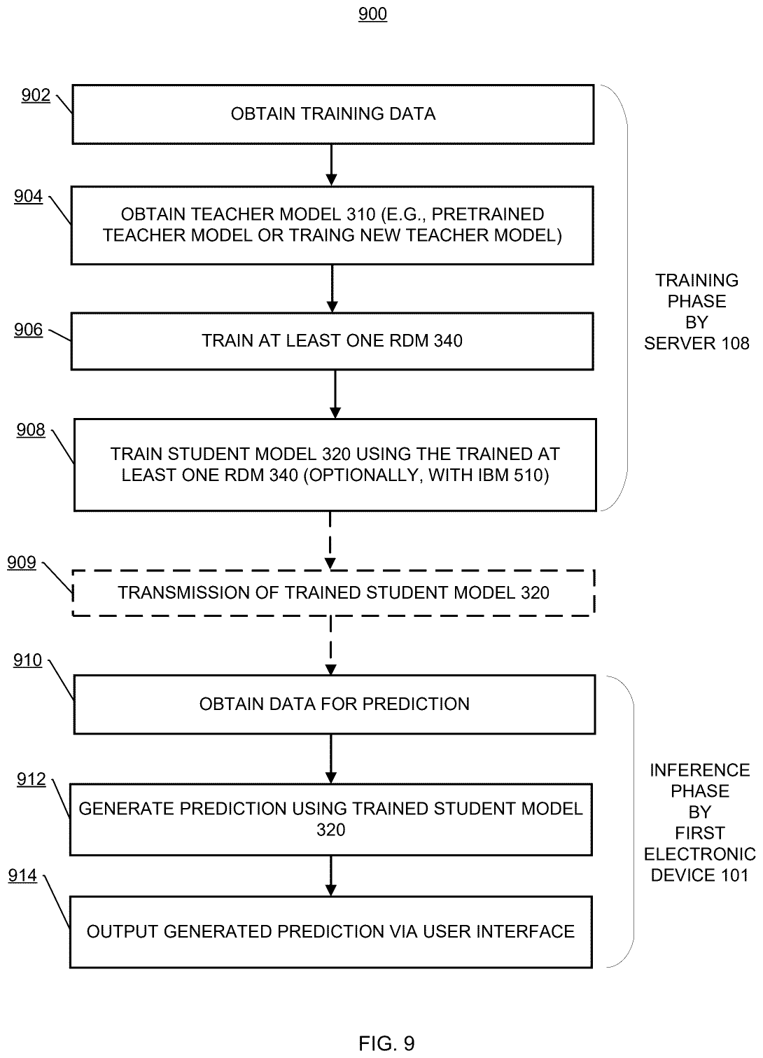

FIG. 9 illustrates example set of operations 900 in accordance with some embodiments of the disclosure. At operation 902, the server 108 obtains training data. At operation 904, the server 108 obtains a teacher model 310. Examples of the teacher model 310 are a pretrained teacher model 310 and a new teacher model 310 to be trained by the server 108.

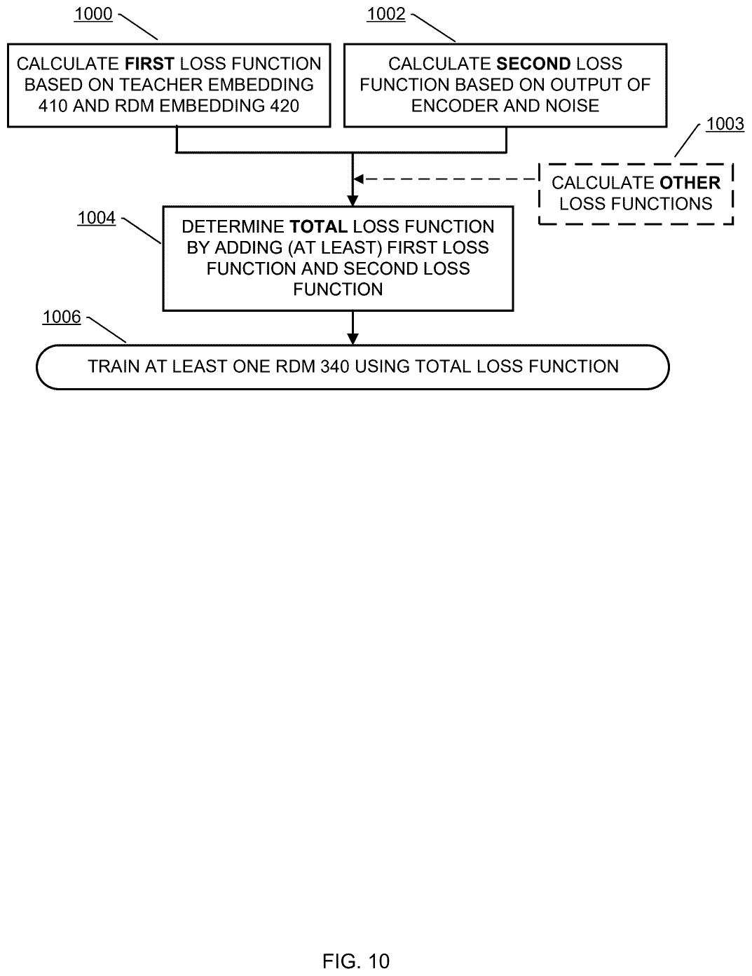

At operation 906, the server 108 trains at least one RDM 340, for example, as illustrated in FIG. 4 and FIG. 6 and as described above. Also, FIG. 10 illustrates sub-operations of operation 906.

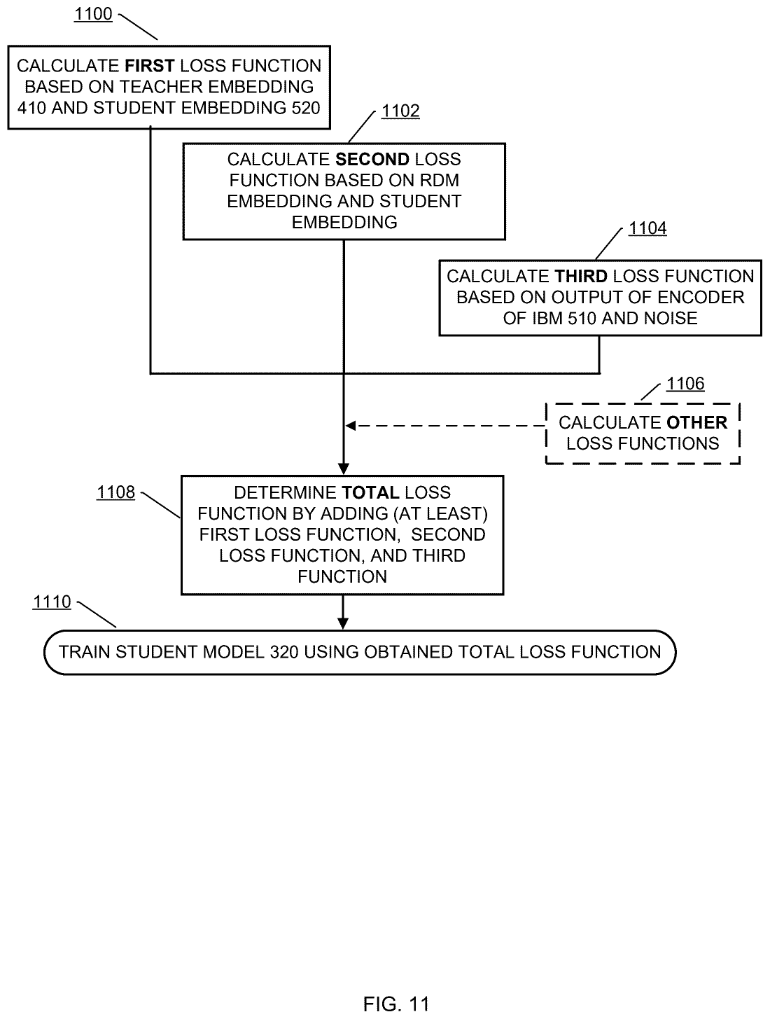

At operation 908, the server 108 trains a student model 320 using the trained at least one RDM 340, optionally, with the IBM 510, for example, as illustrated in FIG. 5 and FIG. 7 and as described above. Also, FIG. 11 illustrates sub-operations of operation 908.

As shown in FIG. 9, the server 108 performs operations 902 to 908 during a training phase.

At operation 909, the server 108 transmits the trained student model 320 to the first electronic device 101 (e.g., the user terminal). Operation 909 may be equal to or correspond to operation 802 of FIG. 8. In some embodiment, the server 108 receives a command from a user through the user interface 210 shown in the display 208. The user may select the trained student model through the user interface 210 and instruct to transmit the selected trained student model from the server 108 to the first electronic device 101. In some embodiments, the server 108 may transmit the trained student model 320 to the first electronic device 101 even without any request from the first electronic device 101.

At operation 910, the first electronic device 101 obtains data for prediction. For example, the data for prediction are data for chatbot services (representing users' queries), data for chat assistants (representing users' queries), data for analysis, and data for business intelligence.

At operation 912, the first electronic device 101 generates the prediction using the trained student model 320. That is, the first electronic device 101 provides the obtained data to the trained student model 320 and obtains results of the prediction (e.g., the chatbot services (outputting answers to the users' queries), chat assistants (outputting answers to the users' queries), the analysis, or the business intelligence) from the trained student model 320.

At operation 914, the first electronic device 101 outputs the generated prediction through a user interface of the first electronic device 101. For example, a user of the first electronic device 101 receives, via the user interface of the first electronic device 101, chat responses generated by the trained student model 320.

As shown in FIG. 9, the first electronic device 101 performs operations 910 to 914 during an inference phase.

FIG. 10 illustrates example sub-operations of operation 906 (training the at least one RDM 340), which are illustrated in FIG. 4 or FIG. 6.

At operation 1000, the server 108 calculates a first loss function based on the teacher embeddings 410 and the RDM embeddings 420.

At operation 1002, the server 108 calculates a second loss function based on an output of the encoder 344 and noise.

At operation 1003, optionally, the server 108 calculates other loss functions.

At operation 1004, the server 108 determines a total loss function by adding (at least) the first loss function and the second loss function.

At operation 1006, the server 108 trains the at least one RDM 340 using the total loss function determined at operation 1004.

FIG. 11 illustrates example sub-operations of operation 908 (training the student model 320), which are illustrated in FIG. 5 or FIG. 7.

At operation 1100, the server 108 calculates a first loss function based on the teacher embeddings 410 and the student embeddings 520.

At operation 1102, the server 108 calculates a second loss function based on the RDM embeddings 420 and the student embeddings 520.

At operation 1104, the server 108 calculates a third loss function based on an output of an encoder of the IBM 510 and noise.

At operation 1106, optionally, the server 108 calculates other loss functions.

At operation 1108, the server 108 determines a total loss function by adding (at least) the first loss function, the second loss function, and the third loss function.

At operation 1110, the server 108 trains the student model 320 using the total loss function determined at operation 1108.

One or more embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store, or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities. According to one or more embodiments, one or more of the above-described components may be omitted, or one or more other components may be added. In some embodiments, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

According to one or more embodiments, in non-volatile storage medium storing instructions, the instructions may be configured to, when executed by at least one processor, cause the at least one processor to perform at least one operation. The at least one operation may include displaying an application screen of a running application on a display, identifying a data input field included in the application screen, identifying a data type corresponding to the data input field, displaying at least one external electronic device, around the electronic device, capable of providing data corresponding to the identified data type, receiving data corresponding to the identified data type from an external electronic device selected from among the at least one external electronic device through a communication circuit, and entering the received data into the data input field.

The embodiments of the disclosure described in the disclosure and the drawings are only presented as specific examples to easily explain the technical content according to the embodiments of the disclosure and help understanding of the embodiments of the disclosure, not intended to limit the scope of the embodiments of the disclosure. Therefore, the scope of one or more embodiments of the disclosure should be construed as encompassing all changes or modifications derived from the technical spirit of one or more embodiments of the disclosure in addition to the embodiments disclosed herein.

What is claimed is:

1. A computer-implemented method performed by an electronic device configured to distill knowledge from a teacher model and transfer the distilled knowledge to a student model, the computer-implemented method comprising:
obtaining training data;
obtaining the teacher model;
training at least one rate distortion module (RDM) that is not a teacher assistant (TA) model;
training the student model using the trained at least one RDM; and
transmitting the trained student model to a first electronic device.

2. The computer-implemented method of claim 1, wherein the transmitting the trained student model to a first electronic device, comprises:
receiving, via a user interface of a display in the electronic device, a user's first command to select the trained student model,
receiving, via the user interface, the user's second command to transmit the trained student model to the first electronic device, and
transmitting, based on the user's second command, the trained student model to a first electronic device.

3. The computer-implemented method of claim 1, wherein the teacher model is a large language model (LLM) and the student model is a small language model (SLM).

4. The computer-implemented method of claim 1, wherein the teacher model is a pretrained model that is pretrained by an external device.

5. The computer-implemented method of claim 1, wherein the teacher model is a large language model trained by the electronic device.

6. The computer-implemented method of claim 1, wherein the first electronic device is a user terminal.

7. The computer-implemented method of claim 1, the training the at least one RDM, comprises:
calculating a first loss function based on teacher embeddings and RDM embeddings;
calculating a second loss function based on an output of an encoder and noise;
determining a total loss function by adding at least the first loss function and the second loss function; and
training the at least one RDM using the determined total loss function.

8. The computer-implemented method of claim 7, further comprising calculating other loss functions,
wherein the determining the total loss function by adding at least the first loss function and the second loss function comprises determining the total loss function by the first loss function, the second loss function, and the other loss functions.

9. The computer-implemented method of claim 1, the training the student model using the trained at least one RDM, comprises:
calculating a first loss function based on teacher embeddings and student embeddings;
calculating a second loss function based on RDM embeddings and the student embeddings;
calculating a third loss function based on an output of an encoder of an information bottleneck module (IBM) and noise;
determining a total loss function by adding at least the first loss function, the second loss function, and the third loss function; and
training the at least one RDM using the determined total loss function.

10. The computer-implemented method of claim 8, further calculating other loss functions,
wherein the determining the total loss function by adding at least the first loss function, the second loss function, and the third loss function comprises determining the total loss function by the first loss function, the second loss function, the third loss function, and the other loss functions.

11. An electronic device configured to distill knowledge from a teacher model and transfer the distilled knowledge to a student model, the electronic device comprising:
at least one memory;
a display displaying a user interface; and
at least one processor operatively connected with the at least one memory and the display;
wherein the at least one processor is configured to perform:
obtaining training data;
obtaining the teacher model;
training at least one rate distortion module (RDM) that is not a teacher assistant (TA) model;
training the student model using the trained at least one RDM; and
transmitting the trained student model to a first electronic device.

12. The electronic device of claim 11, wherein the at least one processor is further configured to perform:
receiving, via the user interface, a user's first command to select the trained student model,
receiving, via the user interface, the user's second command to transmit the trained student model to the first electronic device, and
transmitting, based on the user's second command, the trained student model to a first electronic device.

13. The electronic device of claim 11, wherein the teacher model is a large language model (LLM) and the student model is a small language model (SLM).

14. The electronic device of claim 11, wherein the teacher model is a pretrained model that is pretrained by an external device.

15. The electronic device of claim 11, wherein the teacher model is a large language model trained by the electronic device.

16. The electronic device of claim 11, wherein the first electronic device is a user terminal.

17. The electronic device of claim 11, wherein the at least one processor is further configured to perform:
calculating a first loss function based on teacher embeddings and RDM embeddings;
calculating a second loss function based on an output of an encoder and noise;
determining a total loss function by adding at least the first loss function and the second loss function; and
training the at least one RDM using the determined total loss function.

18. The electronic device of claim 17, the at least one processor is further configured to perform:
calculating other loss functions, and
determining the total loss function by the first loss function, the second loss function, and the other loss functions.

19. The electronic device of claim 11, wherein the at least one processor is further configured to perform:
calculating a first loss function based on teacher embeddings and student embeddings;
calculating a second loss function based on RDM embeddings and the student embeddings;
calculating a third loss function based on an output of an encoder of an information bottleneck module (IBM) and noise;
determining a total loss function by adding at least the first loss function, the second loss function, and the third loss function; and
training the at least one RDM using the determined total loss function.

20. The electronic device of claim 18, wherein the at least one processor is further configured to perform:
calculating other loss functions, and
determining the total loss function by the first loss function, the second loss function, the third loss function, and the other loss functions.
